(19) United States
(12) Patent Application Publication
(10) Pub. No.: US 2017/0200564 A1
(43) Pub. Date: Jul. 13, 2017

(54) DYE-SENSITIZED SOLAR CELL

(71) Applicant: Orion Co., Ltd., Gyeongsangbuk-do (KR)

(72) Inventors: Jae-Kwun Hwang, Gyeongsangbuk-do (KR); Bo Eun Kim, Gyeongsangbuk-do (KR)

(21) Appl. No.: 15/313,051

(22) PCT Filed: Jun. 9, 2015
(86) PCT No.: PCT/KR2015/005757

§ 371 Date: Nov. 21, 2016

(30) Foreign Application Priority Data
Jun. 18, 2014 (KR) 10-2014-0074324

(51) Int. Cl. H01G 9/20

(52) U.S. Cl. CPC H01G 9/2077; H01G 9/2059

(57) ABSTRACT

The present invention relates to a dye-sensitized solar cell in which a contaminant blocking partition wall having a material (for example, a bismuth-based glass frit material, a PbO-based glass frit material and the like) similar to those of upper and lower plates can be additionally arranged at the outermost periphery of an inner partition wall exposed to edges of the upper and lower plates.

### TECHNICAL FIELD

The present disclosure relates to a dye-sensitized solar cell, and more particularly, to a dye-sensitized solar cell further including a contaminant blocking partition wall having a material (for example, bismuth-based glass frit material, PbO-based glass frit material, etc.) similar to those of upper and lower plates at the outermost periphery of an internal partition wall exposed to the edges of the upper and lower plates, to effectively block or shield many contaminants (for example, water, gas, oil, various chemicals, etc.) penetrated or infiltrated into the upper and lower plates from outside without particular difficulty, and significantly increase the bonding strength of the upper and lower plates, allowing the subjects of production to enjoy improved quality advantage of finally produced solar cells as well as enhanced competitive advantage compared to their other products.

### BACKGROUND ART

As shown in FIGS. 1 and 2, a dye-sensitized solar cell 10 according to prior art has a systematically combined configuration including upper and lower plates 21 and 22 made of glass having upper and lower electrodes 51 and 52, a plurality of electrolyte/dye receiving cells 30 that is interposed between the upper and lower plates 21 and 22, separated from each other by an internal partition wall 40 and arranged along the upper and lower plates 21 and 22, and receives an electrolyte and a dye polymer, and a grid electrode 53 that is inserted in the internal partition wall 40 and isolated from the electrolyte. In this case, the upper/lower plates 21 and 22 may be coated with a conductive material (not shown), for example, FTO.

A more detailed structure of the dye-sensitized solar cell 10 is disclosed by, for example, Korean Patent Publication No. 10-2012-114888 (titled a sealing material for a dye-sensitized solar cell and a method for sealing a dye-sensitized solar cell using the same) (published on Oct. 17, 2012), and Korean Patent No. 10-1223736 (titled an electrolyte for a dye-sensitized solar cell and a dye-sensitized solar cell using the same) (published on Jan. 21, 2013).

On the other hand, under this conventional regime, when sandwich-type assembling and combining of the upper plate 21 and the lower plate 22 that make up the dye-sensitized solar cell 10 is completed by the medium of the internal partition wall 40, the subjects of production perform a process of injecting an electrolyte and a dye polymer through an electrolyte injection port 60 formed on the sides of the upper and lower plates 21 and 22 (in the case of FIG. 1), or a process of injecting an electrolyte and a dye polymer through an electrolyte injection hole 80 formed on the upper plate 21 (in the case of FIG. 2).

Of course, unless a separate additional action is taken after injection of the electrolyte and the dye polymer, a serious problem with leakage of the corresponding electrolyte to outside may occur, so the subjects of production are taking various countermeasures by performing a successive sealing process to dispose a sealing structure 70 at the outer periphery of the upper and lower plates 21 and 22, so that leakage of the electrolyte to outside can be inhibited beforehand through the sealing structure 70.

For example, Korean Patent Publication No. 10-2010-116797 (titled a sealing apparatus for a solar cell and its control method) (published on Nov. 2, 2010), and Korean Patent Publication No. 10-2013-23929 (titled an electrolyte sealing structure of a dye-sensitized solar cell) (published on Mar. 8, 2013) disclose an example of an electrolyte sealing method according to prior art in more detail.

Under this conventional regime, as shown in FIGS. 1 and 2, because the internal partition wall 40 unavoidably comes into direct contact with the electrolyte fully filled in the electrolyte/dye receiving cell 30, the subjects of production select, as a material of the internal partition wall 40, a series of electrolyte blocking materials that can show a strong blocking quality against electrolytes, for example, vanadate and silicate.

However, these electrolyte blocking materials can show a strong blocking quality against electrolytes, while they show a very low blocking quality against many contaminants penetrated or infiltrated into the upper and lower plates 21 and 22 from outside, for example, water, gas, oil, various types of chemicals, etc. In the end, unless a separate action is taken, the subjects of production cannot avoid serious damage of internal contamination with many contaminants (for example, water, gas, oil, various types of chemicals, etc.) penetrated or infiltrated into the upper and lower plates 21 and 22 from outside (Of course, under the situation in which the inside of the upper and lower plates 21 and 22 is severely contaminated, reliability of finally produced solar cells will degrade drastically).

Of course, as shown in FIGS. 1 and 2 described above, although the prior art additionally places the sealing structure 70 at the outer periphery of the upper and lower plates 21 and 22, the sealing structure 70 is made of a series of electrolyte blocking materials (for example, silicon, epoxy, UV epoxy, etc.) that can show a strong blocking quality against only electrolytes. Thus, even under the situation in which the sealing structure 70 is placed, the subjects of production cannot avoid serious damage of the upper and lower plates 21 and 22 contaminated inside with many contaminants (for example, water, gas, oil, various types of chemicals, etc.) penetrated/infiltrated from outside.

### DISCLOSURE

### Technical Problem

Therefore, the present disclosure additionally places a contaminant blocking partition wall having a material (for example, bismuth-based glass frit material, PbO-based glass frit material, etc.) similar to those of upper and lower plates at the outermost periphery of an internal partition wall exposed to the edges of the upper and lower plates, to effectively block/shield many contaminants (for example, water, gas, oil, various types of chemicals, etc.) penetrated/infiltrated into the upper and lower plates from outside without particular difficulty, and significantly increase the bonding strength of the upper and lower plates, allowing the subjects of production to enjoy improved quality advantage of finally produced solar cells as well as enhanced competitive advantage compared to their other products.

Other objects of the present disclosure will be more apparent from the following detailed description and the accompanying drawings.

### Technical Solution

To achieve the object, the present disclosure discloses a dye-sensitized solar cell including an upper plate, a lower plate, and electrolyte/dye receiving cells interposed between the upper plate and the lower plate, wherein the electrolyte/dye receiving cells are separated from each other by an internal partition wall and arranged along the upper plate and the lower plate, and receive an electrolyte and a dye polymer, wherein a contaminant blocking partition wall is placed at an outermost periphery of the internal partition wall exposed to edges of the upper plate and the lower plate to block the penetration of outside contaminant.

### Advantageous Effects

The present disclosure may additionally place a contaminant blocking partition wall having a material (for example, bismuth-based glass frit material, PbO-based glass frit material, etc.) similar to those of upper and lower plates at the outermost periphery of an internal partition wall exposed to the edges of the upper and lower plates. Accordingly, under the environment in which the present disclosure is embodied, it is possible to effectively block and shield many contaminants (for example, water, gas, oil, various types of chemicals, etc.) penetrated/infiltrated into the upper and lower plates from outside without particular difficulty, and significantly increase the bonding strength of the upper and lower plates. In the end, the subjects of production can enjoy improved quality advantage of finally produced solar cells as well as enhanced competitive advantage compared to their other products.

### DESCRIPTION OF DRAWINGS

FIGS. 1 and 2 are diagrams showing an example of a dye-sensitized solar cell according to prior art.

FIG. 3 is a diagram showing an example of a dye-sensitized solar cell according to an embodiment of the present disclosure.

FIG. 4 is a diagram showing an example of a dye-sensitized solar cell according to another embodiment of the present disclosure.

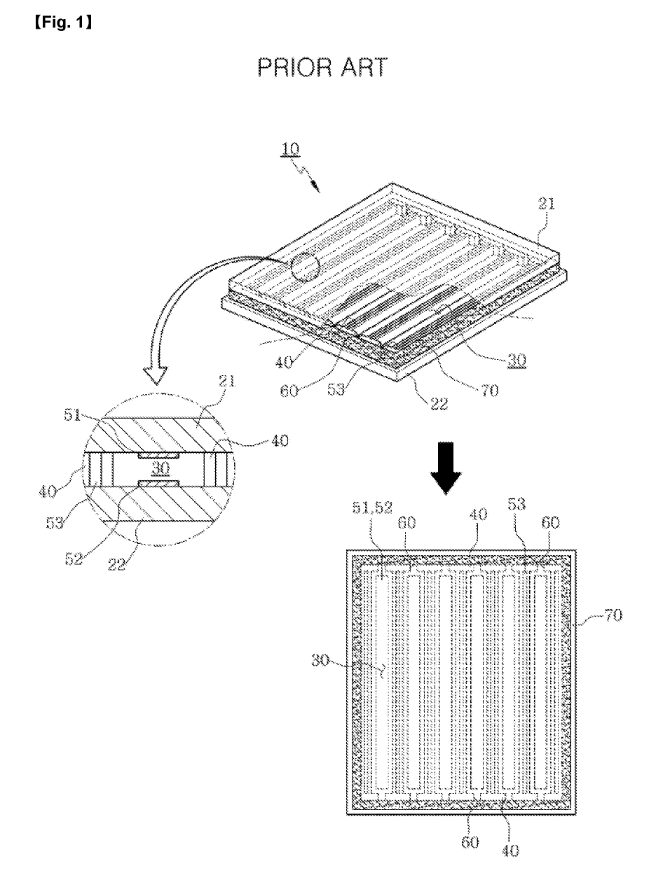

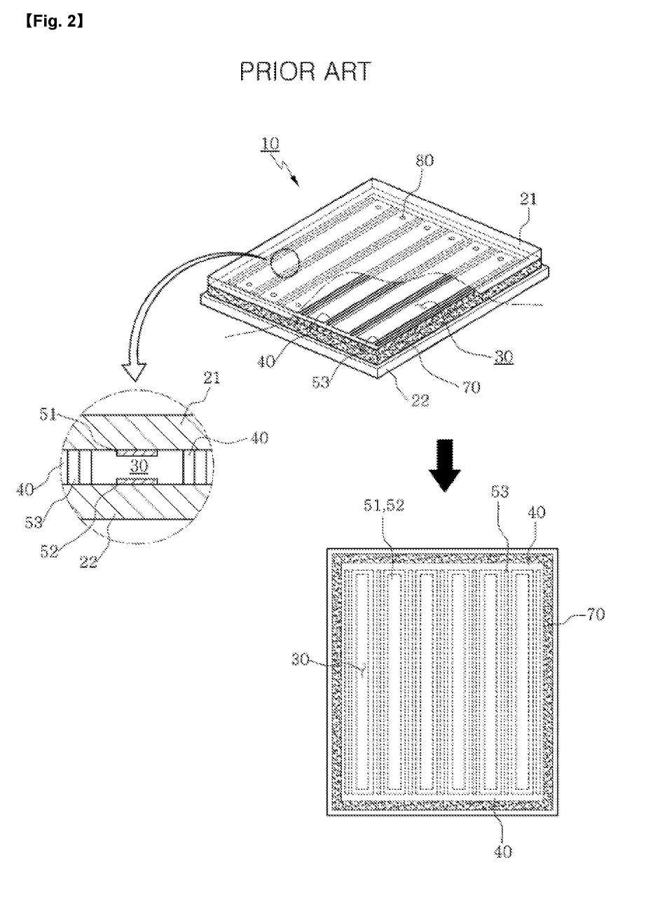

### BEST MODE

Hereinafter, a dye-sensitized solar cell according to the present disclosure will be described below in more detail, with reference to accompanying drawings.

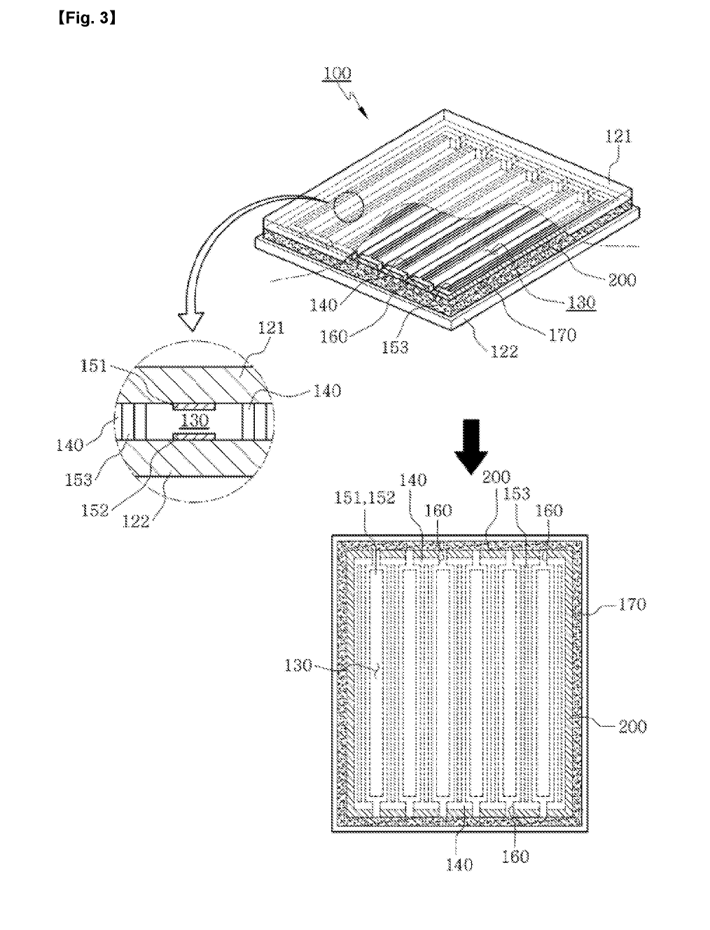

As shown in FIG. 3, the dye-sensitized solar cell 100 according to an embodiment of the present disclosure assumes a systematically combined configuration including upper and lower plates 121 and 122 made of glass having upper and lower electrodes 151 and 152, a plurality of electrolyte/dye receiving cells 130 that is interposed between the upper and lower plates 121 and 122, separated from each other by an internal partition wall 140, and arranged along the upper and lower plates 121 and 122, and receives an electrolyte and a dye polymer, and a grid electrode 153 that is inserted in the internal partition wall 140 and isolated from the electrolyte. In this case, the upper and lower plates 121 and 122 may be coated with a conductive material (not shown), for example, FTO.

On the other hand, under the regime of the present disclosure, when sandwich-type assembling/combining of the upper plate 121 and the lower plate 122 that make up the dye-sensitized solar cell 100 is completed by the medium of the internal partition wall 140, the subjects of production perform a process of injecting an electrolyte and a dye polymer through an electrolyte injection port 160 formed on the sides of the upper and lower plates 121 and 122.

Of course, unless a separate additional action is taken after injecting the electrolyte and the dye polymer, a serious problem with leakage of the corresponding electrolyte to outside may occur. Accordingly, the subjects of production take various countermeasures by performing a successive sealing process to dispose a sealing structure 170 at the outer periphery of the upper and lower plates 121 and 122, so that leakage of the electrolyte to outside can be inhibited beforehand through the sealing structure 170.

Under this regime of the present disclosure, because the internal partition wall 140 unavoidably comes into direct contact with the electrolyte fully filled in the electrolyte/dye receiving cell 130, the subjects of production select, as a material of the internal partition wall 140, a series of electrolyte blocking materials that can show a strong blocking quality against electrolytes, for example, vanadate, silicate, etc.

However, although these electrolyte blocking materials can show a strong blocking quality against electrolytes, while they show a very low blocking quality against many contaminants penetrated/infiltrated into the upper and lower plates 121 and 122 from outside, for example, water, gas, oil, various types of chemicals, etc. Accordingly, unless a separate action is taken, the subjects of production cannot avoid serious damage of internal contamination with many contaminants (for example, water, gas, oil, various types of chemicals, etc.) penetrated/infiltrated into the upper and lower plates 121 and 122 from outside (Of course, under the situation in which the inside of the upper and lower plates 121 and 122 is severely contaminated, reliability of finally produced solar cells will degrade drastically).

In this sensitive situation, as a countermeasure, the present disclosure additionally forms and places a contaminant blocking partition wall 200 unique to the present disclosure for blocking the penetration or infiltration of contaminants.

To this end, in the situation in which sandwich-type assembling and combining of the upper plate 121 and the lower plate 122 is performed by the medium of the internal partition wall 140, the present disclosure performs a succession of printing and firing processes targeting the edges of the upper and lower plates 121 and 122, and through this, forms and places <the contaminant blocking partition wall 200 unique to the present disclosure for blocking the penetration of outside contaminants> at the outermost periphery of the internal partition wall 140 exposed to the edges of the upper and lower plates 121 and 122.

As another example, in the situation in which sandwich-type assembling and combining of the upper plate 121 and the lower plate 122 is performed by the medium of the internal partition wall 140, the present disclosure performs a succession of dispensing processes targeting the edges of the upper and lower plates 121 and 122, and through this, additionally forms and places <the contaminant blocking partition wall 200 unique to the present disclosure for blocking the penetration of outside contaminants> at the outermost periphery of the internal partition wall 140 exposed to the edges of the upper and lower plates 121 and 122.

In each case, the present disclosure preferably selects bismuth-based glass frit material or PbO-based glass frit material as a material of the contaminant blocking partition wall 200.

The bismuth-based glass frit and PbO-based glass frit are ceramic materials with outstanding moisture-, oil- and gas-resistant properties. Accordingly, as described above, when the contaminant blocking partition wall 200 unique to the present disclosure having the bismuth-based glass frit material and the PbO-based glass frit material is additionally placed at the outermost periphery of the internal partition wall 140 exposed to the edges of the upper and lower plates 121 and 122, many outside contaminants (for example, water, gas, oil, various types of chemicals, etc.) cannot penetrate or infiltrate into the upper and lower plates 121 and 122 by the blocking activity of the contaminant blocking partition wall 200. In the end, the subjects of production can easily avoid reliability degradation of products caused by the penetration or infiltration of contaminants, allowing the subjects of production to flexibly enjoy improved quality advantage of finally produced solar cells and enhanced competitive advantage compared to their other products.

Particularly, the bismuth-based glass frit and PbO-based glass frit that forms the contaminant blocking partition wall 200 may be a material that is very similar (or identical) to the material (i.e., glass material) of the upper and lower plates 121 and 122. Accordingly, under the situation in which the contaminant blocking partition wall 200 unique to the present disclosure having bismuth-based glass frit material and PbO-based glass frit material is additionally placed at the outermost periphery of the internal partition wall 140 exposed to the edges of the upper and lower plates 121 and 122, when a process for assembling and combining the upper and lower plates 121 and 122 is performed, the corresponding upper and lower plates 121 and 122 forms a very strong bond with each other without particular difficulty by using the contaminant blocking partition wall 200 as a bonding medium. In the end, under the situation in which the present disclosure is embodied, the subjects of production can flexibly enjoy the aforementioned contaminant blocking effect as well as the effect on significantly increased bonding strength of the upper and lower plates 121 and 122.

On the other hand, in realizing the technical spirit of the present disclosure, the present disclosure inspects whether the electrolyte injection port 160 for injecting an electrolyte and a dye polymer is additionally formed at the outer periphery of the internal partition wall 140 exposed to the edges of the upper and lower plates 121 and 122, and as shown in FIG. 3, if the electrolyte injection port 160 for injecting an electrolyte and a dye polymer is additionally formed at the outer periphery of the internal partition wall 140 exposed to the edges of the upper and lower plates 121 and 122, a flexible action may be taken by omitting the placement and formation of the contaminant blocking partition wall 200 at the corresponding electrolyte injection port formation region.

Of course, under this selective placement structure of the contaminant blocking partition wall 200, even though the contaminant blocking partition wall 200 is additionally placed at the outermost periphery of the internal partition wall 140, the subjects of production can easily inject an electrolyte and a dye polymer into the electrolyte/dye receiving cell 130 without particular difficulty by using the electrolyte injection port 160 (For reference, the sealing structure 170 is formed after injecting an electrolyte and a dye polymer through the electrolyte injection port 160).

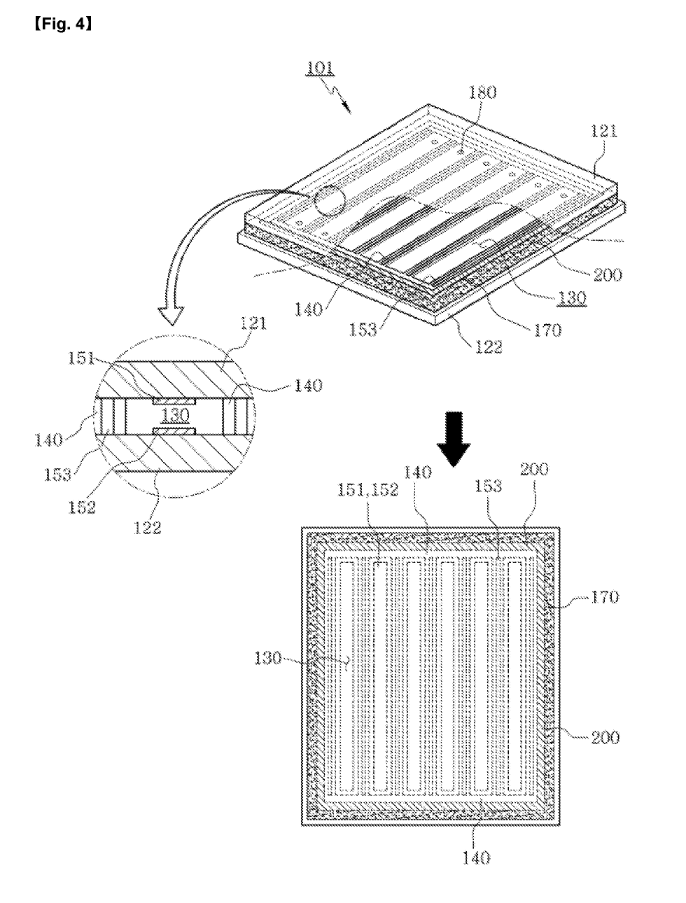

On the other hand, as shown in FIG. 4, as opposed to the previous embodiment, a dye-sensitized solar cell 101 according to another embodiment of the present disclosure assumes a modified type in which an electrolyte and a dye polymer are injected through an electrolyte injection hole 180 formed in the upper plate 121.

Of course, under this another embodiment of the present disclosure, likewise, as a countermeasure, the present disclosure additionally forms and places the contaminant blocking partition wall 200 unique to the present disclosure for blocking the penetration or infiltration of contaminants.

Likewise, in this case, in the situation in which sandwich-type assembling and combining of the upper plate 121 and the lower plate 122 is performed by the medium of the internal partition wall 140, the present disclosure performs a succession of printing and firing processes targeting the edges of the upper and lower plates 121 and 122, and through this, forms and places <the contaminant blocking partition wall 200 unique to the present disclosure for blocking the penetration of outside contaminants> at the outermost periphery of the internal partition wall 140 exposed to the edges of the upper and lower plates 121 and 122.

As another example, in the situation in which sandwich-type assembling and combining of the upper plate 121 and the lower plate 122 is performed by the medium of the internal partition wall 140, the present disclosure performs a succession of dispensing processes targeting the edges of the upper and lower plates 121 and 122, and through this, additionally forms and places <the contaminant blocking partition wall 200 unique to the present disclosure for blocking the penetration of outside contaminants> at the outermost periphery of the internal partition wall 140 exposed to the edges of the upper and lower plates 121 and 122.

In this instance, as opposed to the previous embodiment, because the dye-sensitized solar cell 101 according to another embodiment of the present disclosure assumes the type of injecting an electrolyte and a dye polymer through the electrolyte injection hole 180 formed in the upper plate 121, under another embodiment of the present disclosure, the contaminant blocking partition wall 200 favorably assumes a structure that completely surrounds the entire outermost periphery of the internal partition wall 140 exposed to the edges of the upper and lower plates 121 and 122 without a separate care about the electrolyte injection port (i.e., without a separate omission area) (comparison/reference to FIGS. 3 and 4).

Likewise, in each of these cases, the present disclosure preferably bismuth-based glass frit material or PbO-based glass frit material as a material of the contaminant blocking partition wall 200.

Of course, as described above, the bismuth-based glass frit and PbO-based glass frit are ceramic materials with outstanding moisture-, oil- and gas-resistant properties. Accordingly, when the contaminant blocking partition wall 200 unique to the present disclosure having the bismuth-based glass frit material and the PbO-based glass frit material is additionally placed at the outermost periphery of the internal partition wall 140 exposed to the edges of the upper and lower plates 121 and 122, many outside contaminants (for example, water, gas, oil, various types of chemicals, etc.) cannot penetrate or infiltrate into the upper and lower plates 121 and 122 by the blocking activity of the contaminant blocking partition wall 200. In the end, under another embodiment of the present disclosure, likewise, the subjects of production can easily avoid reliability degradation of products caused by the penetration/infiltration of contaminants, allowing the subjects of production to flexibly enjoy improved quality advantage of finally produced solar cells and enhanced competitive advantage compared to their other products.

Particularly, under another embodiment of the present disclosure, likewise, the bismuth-based glass frit and PbO-based glass frit that forms the contaminant blocking partition wall 200 may be a material that is very similar (or identical) to the material (i.e., a glass material) of the upper and lower plates 121 and 122. Accordingly, under the situation in which the contaminant blocking partition wall 200 unique to the present disclosure having bismuth-based glass frit material and PbO-based glass frit material is additionally placed at the outermost periphery of the internal partition wall 140 exposed to the edges of the upper and lower plates 121 and 122, when a process for assembling and combining the upper and lower plates 121 and 122 is performed, the corresponding upper and lower plates 121 and 122 form a very strong bond with each other without particular difficulty by using the contaminant blocking partition wall 200 as a bonding medium. In the end, under another environment in which the present disclosure is embodied, likewise, the subjects of production can flexibly enjoy the aforementioned contaminant blocking effect as well as the effect on significantly increased bonding strength of the upper/lower plates 121 and 122.

The present disclosure is not limited to a particular field, and produces a useful effect across many fields in which inhibition of electrolyte leakage is required.

Furthermore, although particular embodiments of the present disclosure have been hereinabove described and illustrated, it is obvious to those skilled in the art to practice the present disclosure in various modified forms.

It is noted that such modifications should not be individually understood from the technical spirit or perspective of the present disclosure and fall within the scope of the appended claims of the present disclosure.

1. A dye-sensitized solar cell, comprising:
an upper plate;
a lower plate; and
electrolyte/dye receiving cells interposed between the upper plate and the lower plate, wherein the electrolyte/dye receiving cells are separated from each other by an internal partition wall and arranged along the upper plate and the lower plate, and receive an electrolyte and a dye polymer,
wherein a contaminant blocking partition wall is placed at an outermost periphery of the internal partition wall exposed to edges of the upper plate and the lower plate to block the penetration of outside contaminant.

2. The dye-sensitized solar cell according to claim 1, wherein in case that an electrolyte injection port for injecting the electrolyte and the dye polymer is formed at the outer periphery of the internal partition wall exposed to the edges of the upper plate and the lower plate, placement of the contaminant blocking partition wall is omitted at a region in which the electrolyte injection port is formed.

3. The dye-sensitized solar cell according to claim 1, wherein the contaminant blocking partition wall has bismuth-based glass frit material or PbO-based glass frit material.

4. The dye-sensitized solar cell according to claim 1, wherein the contaminant blocking partition wall is formed by a printing process or a dispensing process.
